(19) United States
(12) Patent Application Publication
(10) Pub. No.: US 2019/0140494 A1
(43) Pub. Date: May 9, 2019

(54) ELECTRIC MOTOR WITH LOW COGGING TORQUE

(71) Applicant: Industrial Technology Research Institute, Hsin-chu (TW)

(72) Inventor: I-WEI LAN, Taoyuan City (TW)

(21) Appl. No.: 15/822,506

(22) Filed: Nov. 27, 2017

(30) Foreign Application Priority Data
Nov. 7, 2017 (TW) 106138502

(51) Int. Cl. H02K 1/16; H02K 21/14

(52) U.S. Cl. CPC H02K 1/16; H02K 2213/03; H02K 21/14

(57) ABSTRACT

An electric motor with a low cogging torque comprises a stator and a rotor. The stator comprises a plurality of stator teeth and a plurality of stator slots, wherein a number of the plurality of stator teeth is equal to a number of the plurality of stator slots, and the number of the plurality of stator slots is S. The rotor is disposed inside the stator, wherein the rotor comprises a plurality of magnetic poles, and a number of the plurality of magnetic poles is P, a ratio S/P of the number of the plurality of stator slots to the number of the plurality of magnetic poles is 7.5N, where the N is a positive integer.

### CROSS REFERENCE TO RELATED APPLICATION

This application claims the priority benefits of Taiwan application No. 106138502, entitled “ELECTRIC MOTOR WITH LOW COGGING TORQUE”, and filed on Nov. 7, 2017. The entirety of which is incorporated by reference herein.

### TECHNICAL FIELD

The present disclosure relates to an electric motor with a low cogging torque.

### BACKGROUND

Some electronic products are equipped with and driven by motors, so that the electronic products are able to make corresponding functions. Among several types of motors, the most common motor is an induction motor. In addition, the permanent magnet motor and the reluctance motor have some advantages of simple structures, easy maintenance, and high efficiency, thereby gradually receiving attention.

Since the permanent magnet motor has magnets in a rotor, in the absence of additional current, torque will be changed under rotor rotation, known as cogging torque. When the cogging torque of the motor is high, unnecessary virtual work is produced, resulting in the operation of the motor is not smooth enough.

Therefore, how to improve and provide an electric motor with a lower cogging torque to avoid the above-mentioned problems is an urgent issue in the industry.

### SUMMARY

The present disclosure provides an electric motor with a low cogging torque, which solves the problem that the electric motor jitters or vibrates during rotation, and reduces the cogging torque so as to improve the motor efficiency.

In an embodiment of the present disclosure, an electric motor with a low cogging torque comprises a stator and a rotor. The stator comprises a plurality of stator teeth and a plurality of stator slots, wherein a number of the plurality of stator teeth is equal to a number of the plurality of stator slots, and the number of the plurality of stator slots is S. The rotor is disposed inside the stator, wherein the rotor comprises a plurality of magnetic poles, and a number of the plurality of magnetic poles is P, a ratio S/P of the number of the plurality of stator slots to the number of the plurality of magnetic poles is 7.5N, where the N is a positive integer.

Based on the above-mentioned, in the electric motor with a low cogging torque of the present disclosure, the specific ratio (7.5N) of the stator slots to the magnetic poles solves the problem that the electric motor jitters or vibrates during rotation due to an uneven electromagnetic force.

The foregoing will become better understood from a careful reading of a detailed description provided herein below with appropriate reference to the accompanying drawings.

### BRIEF DESCRIPTION OF THE DRAWINGS

FIG. 1 is a schematic diagram illustrating an electric motor with a low cogging torque in accordance with an embodiment of the present disclosure.

FIG. 2 is a partially enlarged schematic diagram of FIG. 1 in accordance with an embodiment of the present disclosure.

FIG. 3 is a partially enlarged schematic diagram of FIG. 1 in accordance with another embodiment of the present disclosure.

FIG. 4 is a partially enlarged schematic diagram of FIG. 1 in accordance with yet another embodiment of the present disclosure.

FIG. 5 is a three-dimensional schematic diagram illustrating a cogging torque sensitivity analysis of an electric motor with a low cogging torque in accordance with another embodiment of the present disclosure.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

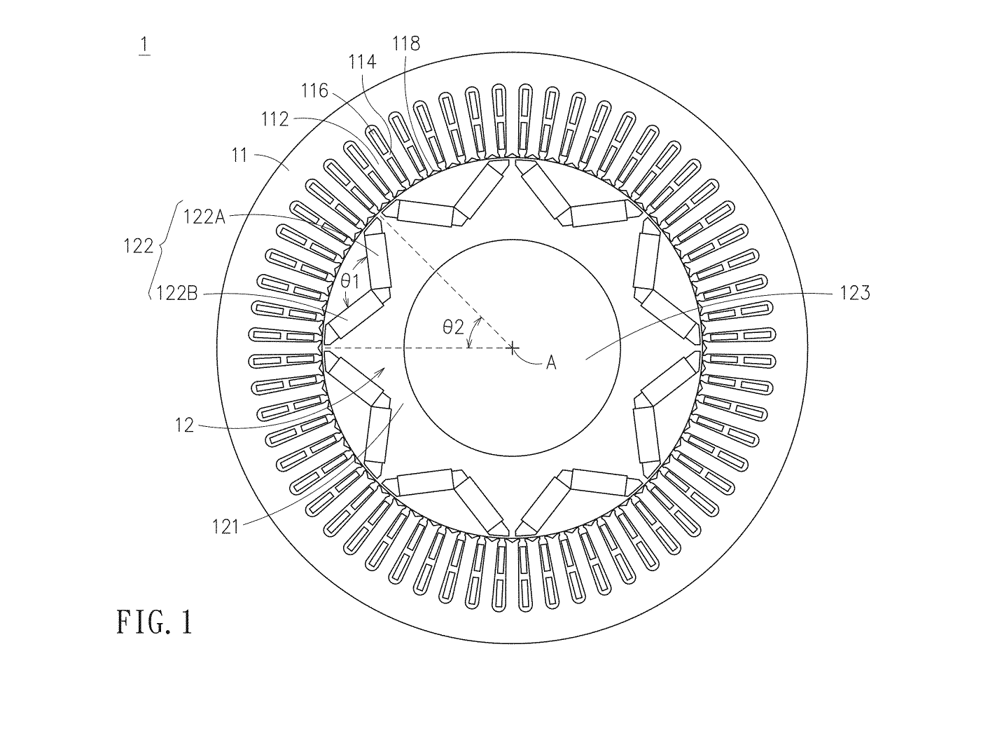

FIG. 1 is a schematic diagram illustrating an electric motor with a low cogging torque in accordance with an embodiment of the present disclosure. Referring to FIG. 1, an electric motor 1 with a low cogging torque comprises a stator 11 and a rotor 12. The stator 11 comprises a plurality of stator teeth 112, a plurality of stator slots 114, a plurality of coils 116, and a plurality of grooves 118. The stator teeth 112 are interconnected with each other to form the stator 11 having a circular shape. There is a stator slot 114 between two stator teeth 112. There is a coil 116 located in a stator slot 114. The coils 116 are wounded around the stator teeth 112. In this embodiment, a number of the stator teeth 112 is equal to a number of the stator slots 114. The stator teeth 112 are radially arranged.

In an embodiment, the rotor 12 is disposed inside the stator 11. A rotary shaft 123 penetrates through the rotor 12. When a current flows through the coils 116, the rotor 12 is driven by a rotation of the rotary shaft 123. Thus, the electric motor 1 with a low cogging torque is driven. The rotor 12 comprises an iron core 121 and a plurality of magnetic poles 122. The magnetic poles 122 are disposed on the circumferential portion of the iron core 121. In this embodiment, each one of the magnetic poles 122 comprises two permanent magnets, which are a first permanent magnet 122A and a second permanent magnet 122B. The first permanent magnet 122A connects to the second permanent magnet 122B, which forms a V-shaped profile. An included angle θ1 between the first permanent magnet 122A and the second permanent magnet 122B ranges from 125 to 135 degrees. An arc angle θ2 ranging from 40 to 44 degrees is formed in a distribution from a center A of the rotor 12 to a single one of the magnetic poles 122.

In this embodiment, a number of the stator slots 112 is S. A number of the magnetic poles 122 is P. A ratio S/P of the number of the stator slots 112 to the number of the magnetic poles 122 is 7.5N, where the N is a positive integer. In other words, the electric motor 1 with a low cogging torque has 7.5N of the ratio S/P (the stator slots 112/the magnetic poles 122). In an embodiment, the number S of the stator slots 122 is 60. The number P of the magnetic poles 122 is 8. That is, the electric motor 1 with a low cogging torque in FIG. 1 has 60 stator slots and 8 magnetic poles.

Under the above configuration, the specific ratio (7.5N) of the stator slots to the magnetic poles solves the problem that the electric motor jitters or vibrates during rotation due to an uneven electromagnetic force. An end portion of each one of the stator teeth 112 comprises at least one groove 118, which performs an arc modification to the end portion of said each of the stator teeth 112. By using the one or more grooves 118 of the stator teeth 112, ripples of the air gap flux become a smoother sine wave so as to reduce the cogging torque. Referring to Table 1, the row of “before the arc modification” represents no groove is on any end portion of the stator teeth 112. The row of “after the arc modification” represents the grooves 118 on the end portions of the stator teeth 112. As shown in Table 1, the present disclosure reduces the cogging torque after the arc modification. In addition, the torque ripples are greatly reduced so as to improve the efficiency of the electric motors.

TABLE 1

| | phase | cogging | torque | efficiency |
|---|---|---|---|---|
| | current | torque | ripple | (electric motor) |
| before arc | 250 A peak | 157.7 | 19.3% | 98.5% |
| modification | | | | |
| after arc | 250 A peak | 154.4 | 8.5% | 98.6% |
| modification | | | | |
| percentage | NA | −2.1% | −56% | +0.1% |
| of change | | | | |

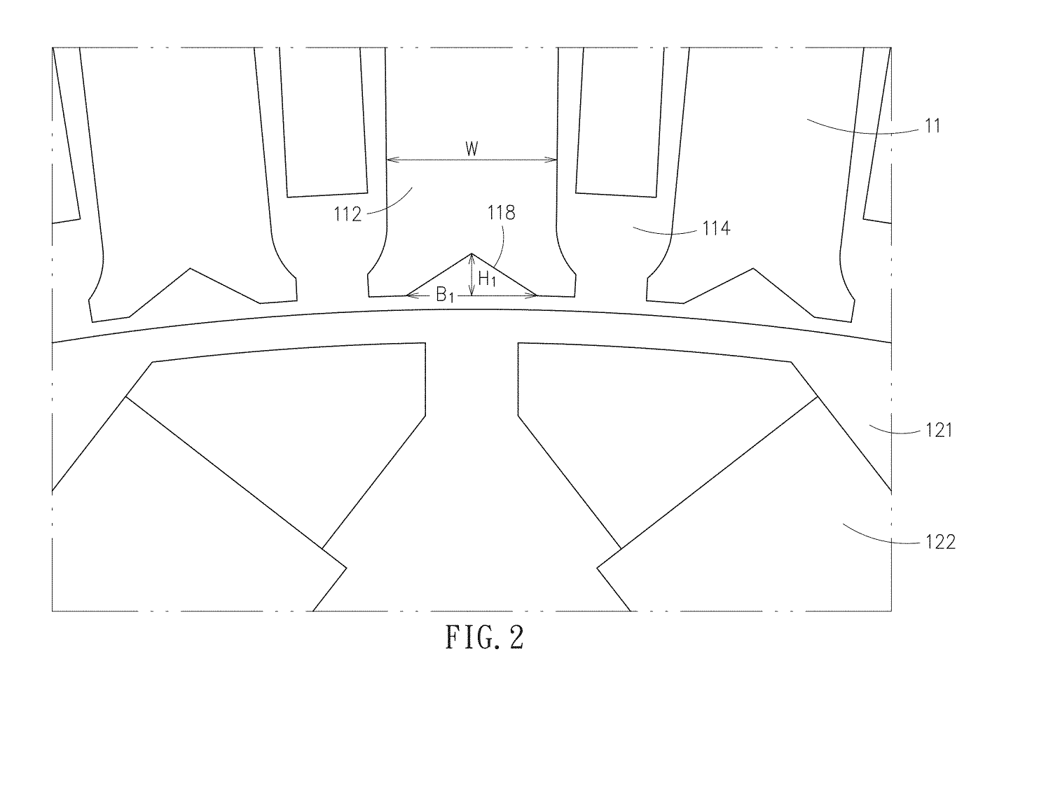

The scope of the profiles of the grooves 118 is not limited to the aforesaid embodiment. Referring to the embodiment of FIG. 2, the groove 118 has a triangular profile. The triangular profile of the groove 118 has a base side B₁ and a height H₁. A length ratio B₁/H₁ of the base side B₁to the height H₁ ranges from 5 to 7. Further, each one of the stator teeth 112 has a width W, and a length ratio B₁/W of the base side B₁to the width W ranges from 0.65 to 0.8. That is, the length of the base side B₁ of the triangular profile of the groove 118 is less than the width W of said each one of the stator teeth 112.

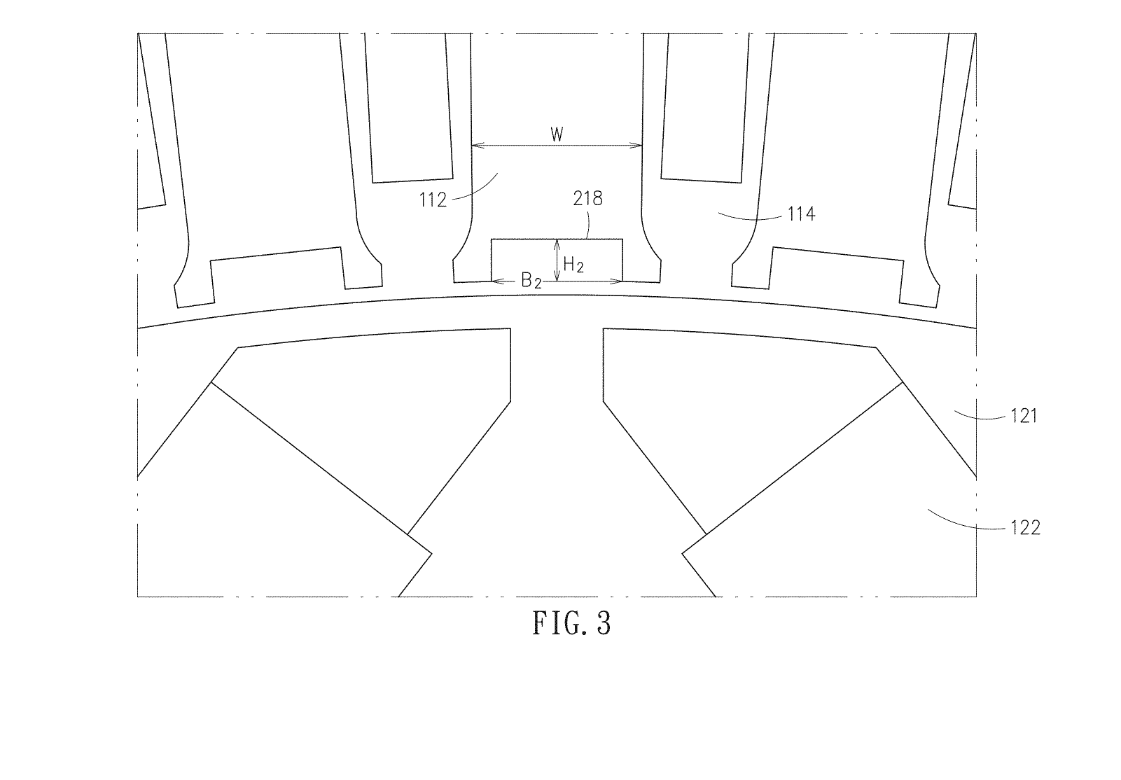

Referring to the embodiment of FIG. 3, the groove 218 has a square profile. The square profile has a base side B₂ and a height H₂. A length ratio B₂/H₂ of the base side B₂to the height H₂ ranges from 5 to 7. Further, each one of the stator teeth 112 has a width W, and a length ratio B₂/W of the base side B₂to the width W ranges from 0.65 to 0.8. That is, the length of the base side B₂ of the square profile of the groove 218 is less than the width W of said each one of the stator teeth 112.

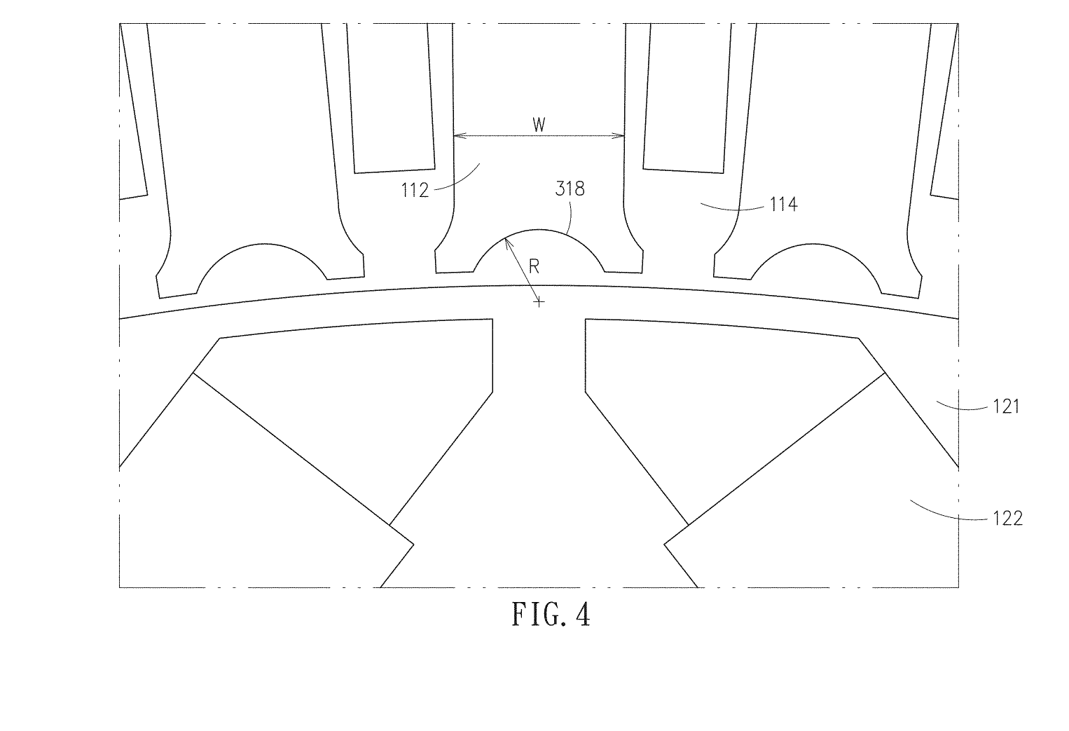

Referring to the embodiment of FIG. 4, the groove 318 has a curved profile. The curved profile has a radius of curvature R, and each one of the stator teeth 112 has a width W. A length ratio R/W of the radius of curvature R to the width W ranges from 0.65 to 0.8. That is, the length of the radius of curvature R of the curved profile of the groove 318 is less than the width W of said each one of the stator teeth 112.

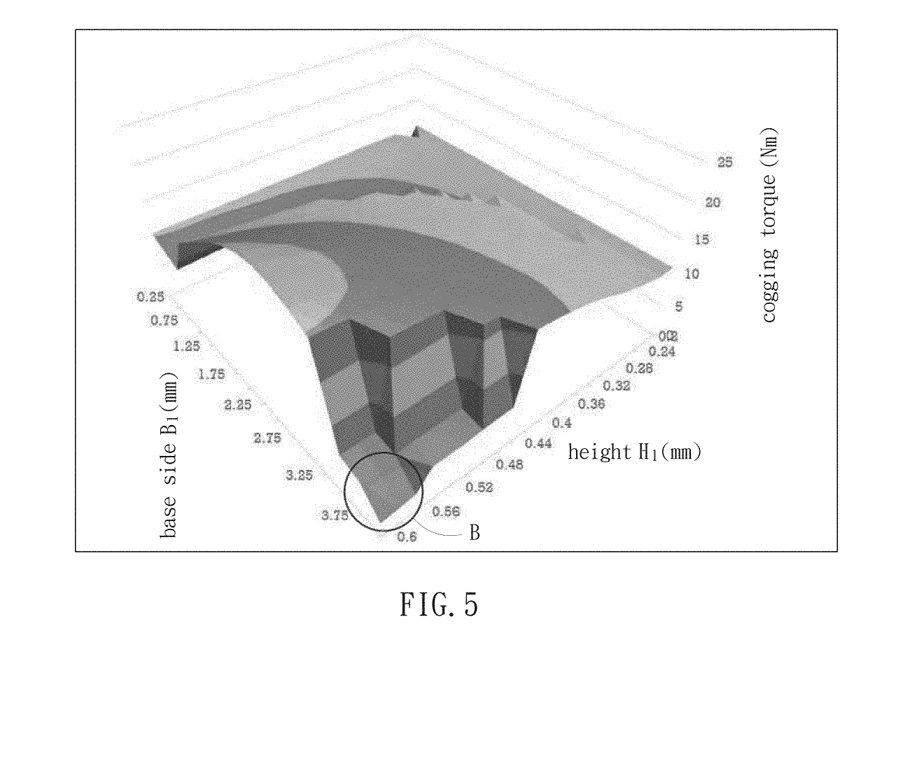

FIG. 5 is a three-dimensional schematic diagram illustrating a cogging torque sensitivity analysis of an electric motor with a low cogging torque in accordance with another embodiment of the present disclosure. Referring to FIG. 5 and FIG. 2, FIG. 5 shows the cogging torque sensitivity analysis between the base side B₁ and the height H₁ of the triangular profile of the groove 118 of FIG. 2. In FIG. 5, the first axis represents the base side B₁ of the triangular profile. The second axis represents the height H₁ of the triangular profile, and the third axis represents the cogging torque. The value of the cogging torque reduces from 10.8 Nm (before the arc modification) to 2.3 Nm (after the arc modification). The more concave of the surface in the three-dimensional contour represents the lower cogging torque. In FIG. 5, the lowest value of the cogging torque is located in region B. The lowest value of the base side B₁ in the region B is 3.75. The lowest value of the height H₁ in the region B is 0.6. Thus, the length ratio B₁/H₁ of the base side B₁ to the height H₁ is 6.25. In the present disclosure, a length ratio B₁/H₁ of the base side B₁to the height H₁ ranges from 5 to 7. Therefore, the length ratio B₁/H₁ of the base side B₁to the height H₁ used in the present disclosure is able to reduce the cogging torque.

According to the disclosed embodiments, the electric motor with a low cogging torque of the present disclosure has a specific ratio (7.5N) of the stator slots to the magnetic poles, which solves the problem that the electric motor jitters or vibrates during rotation due to an uneven electromagnetic force. An end portion of each one of the stator teeth comprises at least one groove, which performs an arc modification to the end portions of said each one of the stator teeth. By using the grooves of the stator teeth, ripples of the air gap flux become a smoother sine wave so as to reduce the cogging torque. In addition, the torque ripples are greatly reduced so as to improve the efficiency of the electric motor.

It will be apparent to those skilled in the art that various modifications and variations can be made to the disclosed embodiments. It is intended that the specification and examples be considered as exemplary embodiments only, with a scope of the disclosure being indicated by the following claims and their equivalents.

What is claimed is:

1. An electric motor with a low cogging torque, comprising:
a stator comprising a plurality of stator teeth and a plurality of stator slots, wherein a number of the plurality of stator teeth is equal to a number of the plurality of stator slots, and the number of the plurality of stator slots is S; and
a rotor disposed inside the stator, wherein the rotor comprises a plurality of magnetic poles, and a number of the plurality of magnetic poles is P, a ratio S/P of the number of the plurality of stator slots to the number of the plurality of magnetic poles is 7.5N, where the N is a positive integer.

2. The electric motor with a low cogging torque according to claim 1, wherein an end portion of each one of the plurality of stator teeth comprises at least one groove.

3. The electric motor with a low cogging torque according to claim 2, wherein the at least one groove has a triangular profile.

4. The electric motor with a low cogging torque according to claim 3, wherein the triangular profile has a base side B₁ and a height H₁, and a length ratio B₁/H₁ of the base side B₁to the height H₁ ranges from 5 to 7.

5. The electric motor with a low cogging torque according to claim 4, wherein each one of the plurality of stator teeth has a width W, and a length ratio B₁/W of the base side B₁to the width W ranges from 0.65 to 0.8.

6. The electric motor with a low cogging torque according to claim 2, wherein the at least one groove has a square profile.

7. The electric motor with a low cogging torque according to claim 6, wherein the square profile has a base side B₂ and a height H₂, and a length ratio B₂/H₂ of the base side B₂to the height H₂ ranges from 5 to 7.

8. The electric motor with a low cogging torque according to claim 7, wherein each one of the plurality of stator teeth has a width W, and a length ratio B₂/W of the base side B₂ to the width W ranges from 0.65 to 0.8.

9. The electric motor with a low cogging torque according to claim 2, wherein the at least one groove has a curved profile.

10. The electric motor with a low cogging torque according to claim 9, wherein the curved profile has a radius of curvature R, each one of the plurality of stator teeth has a width W, a length ratio R/W of the radius of curvature R to the width W ranges from 0.65 to 0.8.

11. The electric motor with a low cogging torque according to claim 1, wherein the number S of the plurality of stator teeth is 60, and the number P of the plurality of magnetic poles is 8.

12. The electric motor with a low cogging torque according to claim 1, wherein each one of the plurality of magnetic poles has two permanent magnets, an included angle between the two permanent magnets ranges from 125 to 135 degrees.

13. The electric motor with a low cogging torque according to claim 1, wherein an arc angle ranging from 40 to 44 degrees is formed in a distribution from a center of the rotor to a single one of the plurality of magnetic poles.
